(19) United States
(12) Patent Application Publication
(10) Pub. No.: US 2022/0227959 A1
(43) Pub. Date: Jul. 21, 2022

(54) SHAPED OBJECT COMPRISING POLYETHYLENE TEREPHTHALATE AND ALUMINIUM

(71) Applicant: SABIC GLOBAL TECHNOLOGIES B.V., Bergen op Zoom (NL)

(72) Inventors: Fayez Abdullah Alfayez, Geleen (NL); Toseef Ahmed, Geleen (NL); Zahir Bashir, Geleen (NL); Hao Gu, Geleen (NL); Saeed Al-Zahrani, Geleen (NL); Ahmed El Nour, Geleen (NL); Arfat Anis, Geleen (NL)

(21) Appl. No.: 17/610,301

(22) PCT Filed: May 25, 2020
(86) PCT No.: PCT/EP2020/064391

§ 371 Date: Nov. 10, 2021

(30) Foreign Application Priority Data
May 21, 2019 (EP) 19175532.1
May 20, 2020 (EP) 20175807.5

(51) Int. Cl. C08K 3/08; C08L 67/02

(52) U.S. Cl. CPC C08K 3/08; C08L 67/02; C08K 2201/005; C08K 2003/0812; C08L 2205/025

(57) ABSTRACT

The present invention relates to a material composition comprising: (i) a polyester selected from polyethylene terephthalate, polybutylene terephthalate, or mixtures thereof; and (ii) ≥1.0 and ≤30.0 vol % of aluminium particles and to a shaped object comprising a material composition comprising such material composition. Such shaped object does demonstrate the desirable mechanical impact properties, and also demonstrates the desirable electromagnetic shielding, electrical conductivity, and thermal conductivity, given its high loading of aluminium.

The present invention relates to a material composition comprising a polyester and aluminium particles. The invention also relates to methods of manufacturing such composition, and to shaped objects.

For certain applications, it is desirable that the material from which an object is produced demonstrates desirably high mechanical properties, such as impact strength, particularly low temperature impact strength, as well as demonstrates desirably high thermal and electrical conductivity, as well as electromagnetic shielding.

Such properties may be provided by using metals for shaping the desired objects. However, metals, in pure form, tend to have certain disadvantages, notably they tend to have a high density, thus rendering objects undesirably heavy, they are prone to corrosion, and fabricating parts that have the desired shape can be difficult.

Alternatively, such properties may be provided by using as material composition a combination of a polymeric material and a metal. In such composition, the polymeric material may provide the desirable mechanical properties, as well as allow the object formed to have a low density, and the metal may provide the thermal and electrical properties. However, many polymeric materials and metals are known to be poorly compatible with each other, so that the desired mechanical properties are not achieved, certainly not where the fraction of metal in the material composition is particularly high, such as is required to induce the desirable conductivity properties.

Furthermore, it is desirable that such material composition be manufactured according to a simple and economic method, allowing to manufacture commercial quantities of the material composition at consistently high quality.

This is now achieved according to the present invention by a material composition comprising:
(i) a polyester selected from polyethylene terephthalate, polybutylene terephthalate, or mixtures thereof; and
(ii) ≥1.0 and ≤30.0 vol % of aluminium particles
   wherein the aluminium particles are present in the form of particles having an average particle size of ≥0.05 and ≤4000 μm, as determined in accordance with ISO 9276-2 (2014).

Such composition demonstrates a desirably high thermal and electrical conductivity, a desirably high toughness, and high flexural modulus and strength.

In the material composition of the present invention, the polyester may be a polyethylene terephthalate, also referred to as PET, or a polybutylene terephthalate, also referred to as PBT.

The PET may for example be a homopolymer or a copolymer. For example, the PET may be a copolymer comprising ≤10.0 wt %, preferably ≤5.0 wt %, of moieties derived from a comonomer, with regard to the total weight of the PET. The comonomer may for example be isophthalic acid.

The PBT may for example be a homopolymer or a copolymer. For example, the PBT may be a copolymer comprising ≤10.0 wt %, preferably ≤5.0 wt %, of moieties derived from a comonomer, with regard to the total weight of the PBT. The comonomer may for example be isophthalic acid.

The polyester as used in the composition of the present invention may for example be a mixture of PET and PBT. For example, the polyester may be a mixture comprising 25.0 and s 75.0 wt % of PET and ≥25.0 and ≤75.0 wt % of PBT, with regard to the total weight of the polyester, preferably ≥25.0 and ≤50.0 wt % of PET and ≥50.0 and ≤75.0 wt % of PBT, more preferably ≥30.0 and ≤45.0 wt % of PET and ≥55.0 and ≤70.0 wt % of PBT.

The aluminium particles that are used in the material composition of the present invention may for example be spherical particles, powdery particles, flakes, micro fibres, or rod-shaped particles. Flake-shaped aluminium particles may also be referred to as platelet particles. Such flake-shape particles are particularly suitable when the material composition is to be used in the manufacturing of thin-walled articles via injection moulding, as during such moulding process, the platelets tend to orient flat and parallel to the surface, which is believed to result in an improvement of the flexural modulus. Micro fibre-shaped aluminium particles, such as micro fibres having a length of ≤1000 μm, are particularly suitable to achieve high electrical conductivity at relatively low loading of aluminium in the polyester.

The aluminium particles preferably have an average particle size of ≥1.0 and ≤1000 μm, more preferably of ≥2.0 and ≤200 μm, even more preferably of ≥5.0 and ≤100 μm, yet even more preferably of ≥10.0 and ≤50.0 μm.

The aluminium particles in certain embodiments of the invention may be coated particles. Preferably, the thickness of the coating is ≤100 nm.

The aluminium particles may for example comprise pure aluminium or an alloy of aluminium and one or more alloying metal(s) selected from silicon, magnesium, manganese, lithium, chromium, titanium, zirconium, zinc, lead, bismuth, nickel and iron, preferably wherein the alloy comprises ≤12.0 wt %, more preferably ≤8.0 wt %, of the alloying metal (s).

It is preferred that the polyester has an intrinsic viscosity of ≥0.45 dg/l, preferably of ≥0.45 and ≤2.50 dl/g, more preferably of ≥0.60 and ≤1.50 dl/g, as determined in accordance with ASTM D2857-95 (2007). Particularly, it is preferred that the polyester is a PET having an intrinsic viscosity of ≥0.45 dg/l, preferably of ≥0.45 and ≤2.50 dl/g, more preferably of 0.60 and ≤1.50 dl/g.

The material composition may for example comprise ≥1.0 and ≤25.0 vol % of aluminium particles, more preferably ≥5.0 and ≤20.0 vol %, even more preferably ≥5.0 and ≤15.0 vol %.

The material composition may for example comprise 10.0 wt % of the polyethylene terephthalate, with regard to the total weight of the material composition. Preferably, the material composition comprises ≥20.0 wt % of the polyethylene terephthalate, more preferably ≥30.0 wt %, or ≥50.0 wt %, or ≥70.0 wt %. The material composition may for example comprise ≤85.0 wt %, or ≤75.0 wt %, or ≤60.0 wt %, or the polyethylene terephthalate. The material composition may for example comprise ≥10.0 and ≤85.0 wt % of the polyethylene terephthalate, or ≥20.0 wt % and ≤75.0 wt %, or ≥30.0 wt % and ≤70.0 wt %.

The material composition may for example consist of the polyester, the aluminium particles, and optionally up to 5.0 wt % of additives. The material composition may for example consist of the polyethylene terephthalate, the aluminium particles, and optionally up to 5.0 wt % of additives. The material composition may for example consist of the polybutylene terephthalate, the aluminium particles, and optionally up to 5.0 wt % of additives. The material composition may for example consist of the polyester, wherein the polyester is a mixture of PET and PBT, the aluminium particles, and optionally up to 5.0 wt % of additives.

It is preferred that, in the shaped object, the aluminium particles are distributed to form a conductive matrix.

The invention in one of its embodiments also relates to a process for production of the material composition, wherein the process involves melt mixing of the polyester and the aluminium particles in a melt extruder. It is preferred that the melt extruder is a twin-screw extruder. It is preferred that the melt mixing is performed at a temperature of between 270° C. and 320° C.

A further embodiment of the invention relating to a method of production of the material composition relates to a process wherein the process involves introduction of the aluminium particles during the polymerisation reaction to manufacture the polyester. Such polymerisation reaction may for example comprise a first step of esterification and a second step of polycondensation, wherein the aluminium particles may be introduced during esterification and/or during polycondensation.

The invention further also relates to a shaped object produced using the material composition of the invention, preferably wherein the shaped object is an injection moulded object or wherein the shaped object is a drawn fibre or filament. Such shaped object may for example be produced by a process involving injection moulding of the material composition to form an object, or involving melt spinning of the material composition to form a fibre or filament.

The invention also relates to the use of a material composition according to the invention for the improvement of the thermal and/or the electrical conductivity of a shaped article.

The present invention further in a certain embodiment also relates to a shaped object comprising a material composition comprising:

(a) a polyethylene terephthalate polymer; and
(b) ≥10.0 wt % of aluminium, with regard to the total weight of the material composition.

Such shaped object does demonstrate the desirable mechanical impact properties, and also demonstrates the desirable electromagnetic shielding, electrical conductivity, and thermal conductivity, given its high loading of aluminium. In such material composition, the polyethylene terephthalate and the aluminium demonstrate good compatibility.

The polyethylene-terephthalate polymer may also be referred to as PET. The material composition as used in the shaped object according to the present invention may also be referred to as a PET-aluminium composite.

The polyethylene terephthalate as used in the material composition in the shaped object may for example be a polyethylene terephthalate homopolymer, or a polyethylene terephthalate copolymer. For example, the PET may be a copolymer comprising ≤10.0 wt %, preferably ≤5.0 wt %, of moieties derived from a comonomer, with regard to the total weight of the PET. The comonomer may for example be isophthalic acid. The polyethylene terephthalate may for example have an intrinsic viscosity of ≥0.45 dl/g, preferable ≥0.80 dl/g, further preferable ≥1.00 dl/g, more preferable ≥1.10 dl/g, as determined in accordance with ASTM D2857-95 (2007). The polyethylene terephthalate may for example have an intrinsic viscosity of ≤2.50 dl/g, further preferable ≤2.00 dl/g, more preferable ≤1.50 dl/g. For example, the polyethylene terephthalate may have an intrinsic viscosity of 0.45 dl/g and ≤2.50 dl/g, alternatively ≥0.80 dl/g and ≤1.50 dl/g.

The material composition may for example comprise ≥10.0 wt % of the polyethylene terephthalate, with regard to the total weight of the material composition. Preferably, the material composition comprises ≥20.0 wt % of the polyethylene terephthalate, more preferably ≥30.0 wt %, or ≥50.0 wt %, or ≥70.0 wt %. The material composition may for example comprise ≤85.0 wt %, or ≤75.0 wt %, or ≤60.0 wt %, or the polyethylene terephthalate. The material composition may for example comprise ≥10.0 and ≤85.0 wt % of the polyethylene terephthalate, or ≥20.0 wt % and ≤75.0 wt %, or ≥30.0 wt % and ≤70.0 wt %.

The material composition may for example comprise ≥15.0 wt % of aluminium, preferably ≥20.0 wt %, more preferably ≥25.0 wt %, or ≥30.0 wt %. The material composition may for example comprise ≤70.0 wt %, preferably ≤60.0 wt %, more preferably ≤50.0 wt % of the aluminium. The material composition may for example comprise ≥10.0 and ≤70.0 wt % of the aluminium, preferably ≥15.0 and ≤60.0 wt %, more preferably ≥20.0 wt % and ≤50.0 wt %.

The material composition may for example consist of the polyethylene terephthalate, the aluminium, and optionally up to 5.0 wt % of additives.

The material composition may for example comprise the polyethylene terephthalate in the form of particles, preferably semi-crystalline particles, and/or the aluminium in the form of particles, preferably wherein the material composition is a powder blend comprising the polyethylene terephthalate and the aluminium.

The polyethylene terephthalate particles may for example have an average particle size of ≥0.5 and ≤4000 μm, and/or the aluminium particles may have an average particle size of ≥0.5 and ≤4000 μm, wherein the average particle size is as determined in accordance with ISO 9276-2 (2014).

The aluminium may be present in the shaped object in the form of distinct particles. For example, the aluminium may be present in the shaped object in the form of particles having an average particle size of ≥0.5 and ≤4000 μm, wherein the average particle size is as determined in accordance with ISO 9276-2 (2014). Preferably, the aluminium particles may have an average particle size of ≥1.0 and ≤1000 μm, more preferably ≥2.0 and ≤200 μm, even more preferably ≥5.0 and ≤100 μm, even more preferably ≥10.0 and ≤50.0 μm.

For example, the material composition may comprise ≥10.0 and ≤70.0 wt % of the aluminium, wherein the aluminium is present in the form of particles having an average particle size of ≥2.0 and ≤200 μm. Preferably, the material composition comprises ≥15.0 and ≤60.0 wt % of the aluminium, wherein the aluminium is present in the form of particles having an average particle size of ≥5.0 and ≤100 μm. More preferably, the material composition comprises ≥15.0 and ≤60.0 wt % of the aluminium, wherein the aluminium is present in the form of particles having an average particle size of ≥10.0 and ≤50.0 μm.

In a certain desirable embodiment of the invention, the material composition comprises ≥50.0 wt % of the sum of the polyethylene terephthalate polymer and the aluminium in the material composition, with regard to the total weight of the material composition, preferably ≥60.0 wt %, more preferably ≥70.0 wt %, even more preferably ≥80.0 wt %, or ≥90.0 wt %, or ≥95.0 wt %, or ≥98.0 wt %. In a certain embodiment, the material composition consists of or consists essentially of the polyethylene terephthalate and the aluminium.

In the context of the present invention, in the embodiment where the material composition consists essentially of the polyethylene terephthalate and the aluminium, this may for example be understood to mean that the material composition contains no further polymers and/or metals, or that the material composition consists of the polyethylene terephthalate, the aluminium and up to 1.0 wt % with regard to the total weight of the material composition of additives.

It is preferred that, in the shaped object, the aluminium is distributed to form a conductive matrix.

The invention also relates to method of manufacturing of the shaped object. In manufacturing of such shaped object, it needs to be ascertained that the manufacturing method does not involve subjecting the material composition to conditions that lead to inferior quality of the object, or that do not allow for manufacturing of the object under economical manufacturing conditions. For example, it is required to ensure that, in the manufacturing process, where melt processing is involved, this does not lead to flow patterns in the shaping step that negatively affect a uniform distribution of the aluminium filler in all directions, so that the distribution of the filler in the shaped object is not uniform throughout. Such flow patterns may for example occur when a shaping process is employed that induces a particularly high shear onto the melt.

Further, it needs to be ascertained that the PET is not subjected to a cooling rate that does negatively affect the formation of a desired crystalline structure. For example, when such crystallisation is performed at an overly fast cooling rate, the crystalline structure may not be uniform throughout the body of the object. This may result in the object to have chemical, mechanical and thermal properties that are negatively affected by this crystallisation process.

An example of a suitable method for manufacturing of the shaped objects according to the present invention is a process comprising the steps in this order of:
(a) providing the material composition;
(b) providing a compacting tool comprising a die having a cavity and a punch having an outer surface corresponding to the cavity;
(c) positioning a quantity of the material composition in the cavity of the die;
(d) exerting a force onto the punch of the compacting tool to compact the material composition so as to fuse the material composition to form one single shaped object;
(e) releasing the force exerted onto the punch;
(f) removing the shaped object from the cavity; and optionally
(g) treating the shaped object at a temperature of between 5° C. below the melting temperature and the melting temperature for a period of between 10 and 60 minutes.

Such process may be understood to be a compaction process. Such process allows for the manufacturing of the shaped object of the present invention in a manner that crystallisation is controlled to avoid undesirably fast crystallisation, and further does not induce a melt shear onto the material as a result of which the distribution of the filled in the shaped object is undesirable.

It is particularly preferred that prior to step (c), the die has been heated to a compaction temperature, preferably wherein the compaction temperature is ≥230° C., more preferably wherein the compaction temperature is ≥230° C. and ≤260° C. It is preferred that the temperature of the die is maintained at the compaction temperature during step (d).

It is further particularly preferred that the force exerted in step (d) is such that the material composition in the cavity is subjected to a pressure of ≥3.0 MPa, preferably ≥10.0 and/or ≤50.0 MPa. Application of such pressure results in the shaped object to have, upon release and removal from the mould, a desirably high mechanical strength.

In the compaction process according to the invention, it is preferred that exertion of the force in step (d) is maintained for ≥1 minute, preferably for ≥5 and ≤15 minutes. In a certain embodiment, the temperature of the die is maintained at the compaction temperature during step (d)

A further suitable process for manufacturing of a shaped object according to the invention comprises the steps in this order of:
(a) providing a quantity of a powder comprising the material composition;
(b) irradiating a portion of the material composition with a radiation source such that the particles in that portion of the material composition absorb sufficient heat to reach a temperature above T_{p,m} of the polyethylene terephthalate polymer;
(c) terminating the exposure of the portion of the material composition to the radiation source so that the temperature of the particles of the material composition decreases to below T_{p,m} of the polyethylene terephthalate polymer;
   wherein steps (a) through (c) are executed in this sequence, wherein steps (a) through (c) may be repeated to form the shaped object, and wherein T_{p,m} is the peak melt temperature determined in accordance with ISO 11357-3 (2011), first heating run.

In such process, material is selectively subjected to a source of radiation in such way that the exposed polymer quantity becomes heated to be sufficiently fluid to fuse or sinter to neighbouring polymer material that is sufficiently heated. In this way, upon cooling, a solidified object is formed having predetermined dimensions, namely according to the material subjected to the radiation. Such process may be referred to as a selective sintering process. Such process also allows for the manufacturing of an object without subjecting the material to excessive melt shear, and accordingly particularly suitable for producing the objects according to the present invention.

A suitable selective sintering process may involve the application of the radiation by means of a laser device. Such process may then be referred to as selective laser sintering. The selective sintering process according to the present invention may for example involve providing a layer of a certain thickness of a powder of the material composition onto a die bed, followed by subjecting a certain portion of the powder to the appropriate radiation, again followed by providing a further layer of powder on top of the previous powder layer in the die, and again subjecting a desired part of that powder layer to the radiation. This may be repeated multiple times to obtain an object of the dimensions at desired.

Particularly, it is desired that the temperature of the powder material that is provided onto the die bed is ≥230° C., particularly preferably ≥230° C. and ≤260° C.

The invention also encompasses an embodiment relating to the use of a shaped object according to the invention for conducting heat or electricity in an article.

The invention will now be illustrated by the following non-limiting examples.

| | |
|---|---|
| PET | Polyethylene terephthalate having an intrinsic viscosity of 1.09 |
| | dl/g, having a heat of fusion of 60 J/g, in powder form with |
| | average particle size 100 μm. |
| Al1 | Aluminium powder, average particle size 30 μm. |
| Al2 | Aluminium powder, average particle size 100 μm. |

For the manufacturing of shaped objects of the present invention, dry powder blends were prepared by mixing PET and aluminium powder material as per the formulations of the table below. The weighed powders were mixed manually in a bottle and agitated. The powder blends according to the examples were dried at 170° C. for three hours.

| Example | PET | Al1 | Al2 |
|---|---|---|---|
| 1 | 100 | | |
| 2 | 90 | 10 | |
| 3 | 80 | 20 | |
| 4 | 70 | 30 | |
| 5 | 60 | 40 | |
| 6 | 75 | | 25 |

The values in the above table indicate the wt % of each ingredient as compared to the total weight of the powder blend.

A cylindrical die was used as a hot compaction tool to make cylindrical compacts with a diameter of 14.5 mm and a length of ca. 5 cm. The compaction die consisted of a barrel and a piston. The walls of the barrel were provided with a heating means, wherein the heaters were covered with insulation. A pressure transducer measured the pressure applied by the piston. 15 Grams of the dried powder, at room temperature, was introduced into the barrel. Next, the piston applied a compacting pressure. A compaction temperature of 245° C. and a pressure of 25 MPa was used for all the compositions. The compaction time including the heat-up time was 10 minutes. After that, the insert at the bottom of the barrel was unscrewed and the billet was pushed out at 245° C. Properties of the prepared object were subsequently tested.

Example 1 is to be considered an example for comparative purposes. The object consisted of pure PET. The cylindrical object could be removed from the mould at 245° C. without sticking. The DSC curve of a sample of material taken from that object only barely showed a Tg, no cold crystallisation, and a melting peak at 257.7° C., with a heat of fusion comparable to that of the starting powder (55.7 J/g). The object was hard and rigid, but chipped at the edges when subjected to an impact test by dropping the object onto a ceramic surface from a height of 1.5 m. The object showed desirable properties for insulation to heat and electricity. When cooled in nitrogen at 77° K, and subjected to hammer impact testing, the object shattered into fragments. Examination of these fragments revealed consolidation with some grain boundaries.

A sample of the composition of example 3 was converted to a shaped object according to the compaction conditions set out above for example 1. A sample of the shaped object was subjected to DSC measurement, revealing a weak Tg, no cold crystallisation peak, and a single melt peak at 249.1° C., with a heat of fusion of 37.5 J/g PET. This indicated that the Pet phase of the composite was semi-crystalline, which would not have been the case if the object would have been prepared by injection moulding using the composition of example 3. When subjecting the object to drop impact test as described above for example 1, chipping at the edges occurred. Examination of the surface of a cross section obtained by liquid nitrogen fracturing revealed that the Al was evenly distributed.

Cylindrical objects based on the material of example 4, prepared according to the method described for example 1, showed a change to metal-dominated behaviour. The appearance of the object was more metallic. The DSC curve showed a single melting peak at 249.9° C. and a heat of fusion of 33.2 J/g PET. This indicated that the PET phase of the composite was semi-crystalline. When subjecting the object to drop impact test as described above for example 1, no chipping occurred, but only denting of the object. Subjecting the object to hammer impact testing under cooled conditions as with example 1 resulted in no break. The electrical and thermal conductivity showed metal-like behaviour.

The cylinder of example 4 was subjected to a further heat treatment to improve the bonding of the PET to the aluminium by placing it in an oven at 260° C. for 30 minutes. The cylinder maintained its shape and dimensions. The cylinder of example 1, i.e. from pure PET, when subjected to such treatment, did fully melt and lose its shape. The cylinder of example 4 demonstrated improved bonding between the PET and the aluminium, as observed in microscopic examination, which is understood to result in the higher impact strength at room temperature as well as in cold impact testing.

The object based on the material of example 5, also prepared according to the method described for example 1, was near aluminium-like in appearance and behaviour. The cylinder object, when tested via DSC, showed a single melting peak at 250.1° C., with a heat of fusion of 43.8 J/g PET. The composition cannot be shaped via injection moulding. When subjecting the object to drop impact test as described above for example 1, no chipping occurred, but only denting of the object. Subjecting the object to hammer impact testing under cooled conditions as with example 1 resulted in no break, even upon subjecting to multiple impacts. The electrical and thermal conductivity showed metal-like behaviour.

The compacted objects as prepared according to examples 3-5, as presented above, provided articles having a density of less than 2 g/cm³, with good impact strength at both room temperature as well as under cooled conditions, and good thermal and electrical conductivity. Further properties of the compacted objects are presented in the table below.

| | Density | Heat of fusion | Peak melting |
|---|---|---|---|
| Example | (g/cm³) | (J/g PET) | temperature (° C.) |
| 1 | 1.35 | 55.7 | 252.7 |
| 3 | 1.58 | 37.5 | 249.1 |
| 4 | 1.81 | 33.2 | 249.9 |
| 5 | 2.07 | 43.8 | 250.1 |

Further experiments were performed using the powder formulations of examples 1, 2 and 6, which were subjected to selective laser sintering (SLS) to form tensile test bars. This method of manufacturing of objects allows for manufacturing of complex shaped without the need for external moulds to be employed. The SLS was performed using a CO₂-laser powered SLS machine, wherein the process parameters were as presented in the table below:

| Parameters (optimized) | | SLS 1 | | SLS 2 | |
|---|---|---|---|---|---|
| Temperature | Part bed temperature | 233° | C. | 230° | C. |
| | Piston temperature | 180° | C. | 180° | C. |
| | Cylinder temperature | 180° | C. | 180° | C. |
| | Feed temperature | 160° | C. | 160° | C. |
| Laser | Laser source | CO₂ | | CO₂ | |
| | Power | 14-18 | W | 18-24 | W |
| | Scan speed | 5 | m/s | 5 | m/s |
| | Hatch distance | 100 | μm | 100 | μm |
| Other | Layer thickness | 100 | μm | 100 | μm |

In experiment SLS1, the powder of examples 1 and 2 was used. In experiment SLS2, the powder of example 6 was used.

The tensile test bars that were produced in the SLS experiments as above had dimensions as in ASTM 0638. The bars were subjected to material testing as in the table below.

| | | SLS 1 | SLS 1 | SLS 2 |
|---|---|---|---|---|
| Material | Testing method | Ex. 1 | Ex. 2 | Ex. 6 |
| Density (g/cm³) | ASTM D792 | 1.36 | 1.45 | 1.52 |
| Tensile Modulus (MPa) | ASTM D638 | 2961 | 3558 | 4057 |
| Tensile Strength (MPa) | ASTM D638 | 66 | 37 | 29 |
| Flexural Modulus (MPa) | ASTM D790 | 2713 | 3179 | 3564 |
| Flexural Strength (MPa) | ASTM D790 | 113 | 79 | 51 |
| IZOD Impact, notched, | ASTM D256 | 26 | 22 | 17 |
| 23° C. (J/m) | | | | |

Further experiments were conducted relating to compounding of polyester/aluminium compositions.

| | |
|---|---|
| PET-B | SABIC PET BC212, a polyethylene terephthalate having an intrinsic viscosity of |
| | 0.84 dl/g, obtainable from SABIC |
| PBT | Valox 310, a polybutylene terephthalate having a melt viscosity of 600 Pa · s, |
| | obtainable from SABIC |
| PC | SABIC PC 0703, a polycarbonate having a melt mass-flow rate of 7.0 g/10 min |
| | at 300° C. under a load of 1.2 kg, obtainable from SABIC |
| PP | SABIC PP500P, a polypropylene having a melt mass-flow rate of 3.1 g/10 min |
| | at 230° C. under a load of 2.16 kg according to ISO 1133, obtainable from |
| | SABIC |
| Al1B | Aluminium powder, average particle size D₅₀ of 20-50 μm, potato and carrot |
| | shaped particles, density 2.7 g/cm³ obtainable from Nanokar, Turkey |
| Al2B | Aluminium nano powder, average particle size D₅₀ of 3 μm, potato and carrot |
| | shaped particles, density 2.7 g/cm³ obtainable from Nanokar, Turkey |
| Al3B | Aluminium flakes, average particle size D₅₀ of 16 μm, density 2.7 g/cm³ |
| | obtainable from Nanografi, Germany |
| Al4B | Aluminium nano powder, spherical, average particle size D₅₀ of 68 nm, density |
| | 2.7 g/cm³, obtainable from Nanografi, Germany |

Using the above materials, a number of formulations were prepared by extrusion melt mixing as presented in the table below:

| Example | Polymer | Aluminium |
|---|---|---|
| 1B | 100.0% PET-B | — |
| 2B | 95.0% PET-B | 5.0% Al1B |
| 3B | 90.0% PET-B | 10.0% Al1B |
| 4B | 85.0% PET-B | 15.0% Al1B |
| 5B | 80.0% PET-B | 20.0% Al1B |
| 6B | 70.0% PET-B | 30.0% Al1B |
| 7B | 95.0% PET-B | 5.0% Al3B |
| 8B | 90.0% PET-B | 10.0% Al3B |
| 9B | 85.0% PET-B | 15.0% Al3B |
| 10B | 80.0% PET-B | 20.0% Al3B |
| 11B | 75.0% PET-B | 25.0% Al3B |
| 12B | 99.0% PET-B | 1.0% Al2B |
| 13B | 97.0% PET-B | 3.0% Al2B |
| 14b | 95.0% PET-B | 5.0% Al2B |
| 15B | 99.0% PET-B | 1.0% Al4B |
| 16B | 97.0% PET-B | 3.0% Al4B |
| 17B | 95.0% PET-B | 5.0% Al4B |
| 18B | 100.0% PBT-B | — |
| 19B | 85.0% PBT-B | 15.0% Al3B |
| 20B | 60.0% PBT, 40.0% PET-B | — |
| 21B | 51.0% PBT, 34.0% PET-B | 15.0% Al3B |
| 22B | 100% PC | — |
| 23B | 95.0% PC | 5.0% Al4B |
| 24B | 85.0% PC | 15.0% Al3B |
| 25B | 100% PP | — |
| 26B | 95.0% PP | 5.0% Al4B |
| 27B | 85.0% PP | 15.0% Al3B |

In the table above, the percentages indicate the percentage by volume of each ingredient vis-á-vis the total volume of the formulation.

Using the formulations of the examples as presented above, an array of physical properties were determined, as shown in the table below.

| Example | 1B | 2B | 3B | 4B | 5B | 6B | 7B | 8B | 9B |
|---|---|---|---|---|---|---|---|---|---|
| Tm | 1.60/1.60* | 1.75 | 1.95 | 2.07 | | | 2.08 | 2.32 | 2.82/2.62* |
| Ts | 59.94/63.31* | 56.55 | 58.33 | 57.23 | | | 66.2 | 71.6 | 79.1/57.22* |
| El | 96.19/5.21* | 135.73 | 16.09 | 13.65 | | | 23.26 | 7.41 | 5.13/3.15* |
| Fm | 2.47/3.49* | 2.74 | 3.18 | 3.24 | | | 3.15 | 4.54 | 5.41/6.86* |
| Fs | 88.98/131.95* | 88.62 | 92.83 | 90.52 | | | 103.1 | 116.7 | 126.0/100.2* |
| Izod | 22.12/30.00 | 26.46 | 39.51 | 51.29 | 43.08 | 31.25 | 45.57 | 44.06 | 43.49/26.04* |
| κ | 0.241 | | | | | | 0.293 | 0.340 | 0.396 |

| Example | 10B | 11B | 12B | 13B | 14B | 15B | 16B | 17B | 18B |
|---|---|---|---|---|---|---|---|---|---|
| Tm | 3.21 | 3.09 | 1.54 | 1.63 | 1.61 | 1.83 | 1.87 | 1.97 | |
| Ts | 76.0 | 72.2 | 55.64 | 56.19 | 55.99 | 62.42 | 52.71 | 40.55 | |
| El | 4.08 | 3.39 | 442.13 | 428.27 | 201.89 | 227.4 | 7.35 | 2.37 | |
| Fm | 6.71 | 8.03 | 2.52 | 2.65 | 2.78 | 2.82 | 3.00 | 3.17 | |
| Fs | 124.2 | 103.4 | 89.39 | 90.14 | 90.34 | 98.71 | 100.51 | 91.37 | |
| Izod | 21.25 | 29.37 | 35.00 | 42.19 | 51.25 | 38.75 | 26.25 | 24.68 | 54.06 |
| κ | 0.499 | 0.606 | | | | 0.251 | 0.277 | 0.294 | |

| Example | 19B | 20B | 21B | 22B | 23B | 24B | 25B | 26B | 27B |
|---|---|---|---|---|---|---|---|---|---|
| Izod | 68.13 | 35.94 | 53.75 | 963.4 | 50.9 | 55.0 | 83.44 | 92.50 | 50.63 |

The properties indicated with * in the table above were determined on test samples that were injection moulded into specimens at a mould temperature of 170° C., leading to crystallisation of the PET. All other measurements were performed on specimens that were injection moulded at a mould temperature of 30° C., which in the examples using PET resulted in that the PET remained amorphous in the test specimen.

In the table above, the abbreviations represent the below properties:
Tm is the tensile modulus, expressed in MPa, determined in accordance with ASTM D638 (2014);
Ts is the tensile strength, expressed in MPa, determined in accordance with ASTM D638 (2014);
El is the elongation at break, expressed in %, determined in accordance with ASTM D638 (2014);
Fm is the flexural modulus, expressed in MPa, determined in accordance with ASTM D790 (2015);
Fs is the flexural strength, expressed in MPa, determined in accordance with ASTM D790 (2015);
Izod is the notched Izod impact strength at 23° C., expressed in J/m, determined in accordance with ASTM D256 (2010);
K is the thermal conductivity, expressed in W/m·K, determined in accordance with ASTM D5930 (2017).

1. A material composition comprising:
(i) a polyester selected from polyethylene terephthalate, polybutylene terephthalate, or mixtures thereof; and
(ii) ≥1.0 and ≤30.0 vol % of aluminium particles
wherein the aluminium particles are present in the form of particles having an average particle size of ≥0.05 and ≤4000 μm, as determined in accordance with ISO 9276-2 (2014).

2. The material composition according to claim 1, wherein the aluminium particles are spherical particles, powdery particles, flakes, micro fibres, or rod-shaped particles.

3. Material composition according to claim 1, wherein the polyester has an intrinsic viscosity of ≥0.45 dg/l as determined in accordance with ASTM D2857-95 (2007).

4. A process for the production of the material composition according to claim 1, wherein the process involves melt mixing of the polyester and the aluminium particles in a melt extruder.

5. A process for the production of the material composition according to claim 1, wherein the process involves introduction of the aluminium particles during the polymerisation reaction to manufacture the polyester.

6. A shaped object produced using the material composition according to claim 1.

7. The shaped object, according to claim 6, comprising a material composition comprising:
(a) a polyethylene terephthalate polymer; and
(b) ≥10.0 wt % of aluminium, with regard to the total weight of the material composition.

8. The shaped object according to claim 6, wherein the polyethylene terephthalate has an intrinsic viscosity of ≥0.45 dl/g as determined in accordance with ASTM D2857-95 (2007).

9. The shaped object according to claim 6, wherein, in the shaped object, the aluminium is distributed to form a conductive matrix.

10. A process for manufacturing of a shaped object according to claim 6, wherein the process comprises the steps in this order of:
a. providing the material composition;
b. providing a compacting tool comprising a die having a cavity and a punch having an outer surface corresponding to the cavity;
c. positioning a quantity of the material composition in the cavity of the die;
d. exerting a force onto the punch of the compacting tool to compact the material composition so as to fuse the material composition to form a shaped object;
e. releasing the force exerted onto the punch;
f. removing the shaped object from the cavity; and optionally
g. treating the shaped object at a temperature of between 5° C. below the melting temperature and the melting temperature for a period of between 10 and 60 minutes.

11. The process according to claim 10, wherein the material composition comprises the polyethylene terephthalate in the form of particles.

12. The process according to claim 11, wherein the polyethylene terephthalate particles have an average particle size of ≥0.5 and ≤4000 μm, and/or the aluminium particles have an average particle size of ≥0.5 and ≤4000 μm, wherein the average particle size is as determined in accordance with ISO 9276-2 (2014).

13. The process for manufacturing of a shaped object according to claim 6, wherein the process comprises the steps in this order of:
a. providing a quantity of a powder comprising the material composition;
b. irradiating a portion of the material composition with a radiation source such that the particles in that portion of the material composition absorb sufficient heat to reach a temperature above T_{p,m};
c. terminating the exposure of the portion of the material composition to the radiation source so that the temperature of the particles of the material composition decreases to below T_{p,m};
wherein steps (a) through (c) are executed in this sequence, wherein steps (a) through (c) may be repeated to form the shaped object, and wherein T_{p,m} is the peak melt temperature determined in accordance with ISO 11357-3 (2011), first heating run.

14. (canceled)

15. The shaped object according to claim 6, wherein the shaped object is capable of conducting heat or electricity.
